(19) United States
(12) Patent Application Publication
(10) Pub. No.: US 2026/0352271 A1
(43) Pub. Date: Nov. 5, 2026

(54) BEAMFORMING SETUP FOR INTEGRATED MILLIMETER WAVE (IMMW) NETWORKS

(71) Applicants: Cheng Chen, Camas, WA (US); Laurent Cariou, Milizac (FR); Carlos Cordeiro, Porland, OR (US); Qinghua Li, San Ramon, CA (US)

(72) Inventors: Cheng Chen, Camas, WA (US); Laurent Cariou, Milizac (FR); Carlos Cordeiro, Porland, OR (US); Qinghua Li, San Ramon, CA (US)

(21) Appl. No.: 19/718,979

(22) Filed: Jun. 24, 2026

Related U.S. Application Data
(60) Provisional application No. 63/849,554, filed on Jul. 23, 2025.
(60) Provisional application No. 63/849,313, filed on Jul. 23, 2025.

(51) Int. Cl. H04B 7/0426; H04B 7/06; H04W 76/15

(52) U.S. Cl. CPC H04B 7/043; H04B 7/06952; H04W 76/15

(57) ABSTRACT

An integrated millimeter wave (IMMW) STA, when associated with another IMMW STA, may be configured to perform a beamforming setup with the other IMMW STA using a sub-mmW link to determine beamforming parameters. The IMMW STA may activate a mmW link and perform beamforming training over the mmW link, once activated, using the beamforming parameters. The IMMW STA may communicate data via the mmW link after performance of the beamforming training. The IMMW STA may be configured to activate the mmW link for performing the beamforming training at a target start time that is determined during the beamforming setup.

### PRIORITY CLAIM

This application claims priority under 35 USC 119 to United States Provisional Patent Application Ser. No. 63/849,554, filed Jul. 23, 2025 [reference number AG0519-Z], and United States Provisional Patent Application Ser. No. 63/849,313, filed Jul. 23, 2025 [reference number AG 4032-Z], which are incorporated herein by reference in their entireties.

### TECHNICAL FIELD

Embodiments pertain to wireless communications. Some embodiments relate to wireless local area networks (WLANs). Some embodiments pertain to Integrated Millimeter Wave (mmWave) (IMMW) Technology for WLANs.

### BACKGROUND

The Integrated Millimeter Wave (mmWave) Study Group (IMMW-SG) is a standard study group that aims to define the scope of integrated mmWave operation in Wi-Fi. Different from previous mmWave Wi-Fi standards, namely, IEEE 802.11ad and 802.11ay, the IMMW-SG intends to build the general Wi-Fi operation at mmWave bands on top of the existing physical (PHY) and medium access control (MAC) layers defined in sub-7 GHz.

### BRIEF DESCRIPTION OF THE DRAWINGS

FIG. 1 illustrates an example Beamforming Request/Response frame exchange for Integrated Millimeter Wave (mmWave) (IMMW) networks, in accordance with some embodiments.

FIG. 2A illustrates a beamforming (BF) training sequence assuming Antenna Sector ID information is included in BF packets, in accordance with some embodiments.

FIG. 2B illustrates a BF training sequence assuming Antenna Sector ID information is not included in BF packets, in accordance with some embodiments.

FIG. 3A illustrates a BF training sequence assuming Antenna Sector ID information is not included in BF packets, in accordance with some embodiments.

FIG. 3B illustrates a BF training sequence assuming Antenna Sector ID information is not included in BF packets, in accordance with some embodiments.

FIG. 4 is a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In accordance with some embodiments, an integrated millimeter wave (IMMW) STA, when associated with another IMMW STA, may be configured to perform a beamforming setup with the other IMMW STA using a sub-mmW link to determine beamforming parameters. The IMMW STA may activate a mmW link and perform beamforming training over the mmW link, once activated, using the beamforming parameters. The IMMW STA may communicate data via the mmW link after performance of the beamforming training. In these embodiments, the IMMW STA may be configured to activate the mmW link for performing the beamforming training at a target start time that is determined during the beamforming setup. These embodiments are described in more detail herein.

In some embodiments, the beamforming parameters determined during the beamforming setup for subsequent use in performing the beamforming training comprise timing information and the beamforming packets transmitted and received during the beamforming training do not include an antenna sector ID and comprise solely a sequence of sounding symbols. These embodiments are also described in more detail herein

The pursuit of ever-higher wireless throughput has long pointed toward one fundamental resource: spectrum. The millimeter wave (mmWave) frequency bands, broadly defined as the range spanning 30 GHz to 300 GHz, offer contiguous swaths of unlicensed spectrum many times wider than the combined sub-7 GHz bands that mainstream Wi-Fi has historically occupied. Yet despite this abundance, integrating mmWave into the broader Wi-Fi ecosystem has proven elusive.

Earlier IEEE 802.11 standards such as 802.11ad and 802.11ay were pioneers in mmWave technology, but their designs were exclusively tailored for mmWave communication. This focus resulted in a notable gap in integrating high-frequency mmWave bands with the lower-frequency spectrum and consequently led to increased development and hardware costs. The need for distinct physical layer devices and algorithms specific to mmWave frequencies further emphasized this design limitation. In practice, this meant that 60 GHz Wi-Fi devices based on 802.11ad (WiGig) and 802.11ay evolved along a separate technology track, with their own beacon structures, channel access mechanisms, PHY numerologies, and beamforming training protocols, rather than being natural extensions of the mainstream 802.11 ecosystem. The resulting fragmentation increased implementation complexity and suppressed broad market adoption.

It was against this backdrop that the IEEE 802.11 working group established the Integrated Millimeter Wave Study Group (IMMW SG) with a deliberate strategic shift. The IMMW Study Group's core proposal is that instead of creating a separate and distinct technology as was done for 802.11ad/ay, it would be easier to gain widespread market adoption for mmWave Wi-Fi if the lower-band Wi-Fi PHY design from the core Wi-Fi standards, such as 802.11ax and 802.11be, was reused and scaled up to support mmWave frequency bands. This philosophy of reuse over reinvention defines everything about what is now being standardized as IEEE 802.11bq.

The IMMW Study Group is tasked with defining a Project Authorization Request to address the problem of WLAN non-standalone operation in unlicensed bands between 42 and 71 GHz using single-user (SU) OFDM-based transmissions. An 802.11 device supporting this new amendment must also support 2.4 to 7.25 GHz sub-7 GHz unlicensed band operation. The resulting amendment, formally designated IEEE P802.11bq, expands the multi-link operation (MLO) defined in the sub-7 GHz band specifications to support non-standalone mmWave operation, and leverages or reuses existing PHY and MAC specifications defined for sub-7 GHz, including SU transmission PPDU formats and MAC frames, while defining bandwidth modes operating on non-overlapping channels.

The “non-standalone” designation is architecturally significant: it means the mmWave link in 802.11bq is not intended to operate in isolation. It functions as an additional high-capacity link within a Multi-Link Device (MLD), always anchored by at least one concurrently operating sub-7 GHz link. The specification framework document (IEEE 802.11-25/2187r2, TGbq) makes this mandatory: an MLD with at least one affiliated IMMW STA shall have at least one other affiliated STA operating on an enabled link in the sub-7 GHz band. Furthermore, the framework prohibits operations, such as TID-To-Link Mapping (TTLM) or multi-link reconfiguration, which would leave the IMMW link as the only active link, reinforcing that sub-7 GHz connectivity is always the anchor.

The PHY architecture of 802.11bq is deliberately constructed to maximize commonality with the Extremely High Throughput (EHT) PHY defined in IEEE 802.11be (Wi-Fi 7). The foundational numerology decision, subcarrier spacing, anchors this relationship: the specification mandates that 1.25 MHz is the only supported subcarrier spacing for the data portion of an IMMW PPDU. This matches the 1.25 MHz subcarrier spacing used in 802.11 be's 320 MHz mode, enabling direct reuse of tone plans and OFDM parameters.

The data portion of an IMMW PPDU reuses the EHT non-OFDMA tone plan, scaled to the channel bandwidth in use. For a 320 MHz channel, this means a 256-point FFT with 234 data tones, 8 pilot tones, and appropriate guard and DC tones; for a 640 MHz channel, the FFT size doubles to 512 with 468 data tones. The OFDM symbol duration excluding the guard interval (GI) is 800 ns in both cases, again directly inherited from the EHT PHY. Only two guard interval values are defined: 50 ns and 100 ns, chosen to reflect the shorter delay spreads characteristic of indoor mmWave propagation environments, in contrast to the 800 ns and 1600 ns GI options supported in sub-7 GHz systems.

The 802.11bq specification defines exactly two channel bandwidth modes: 320 MHz and 640 MHz. Channels of the same bandwidth are non-overlapping, and the center frequencies of adjacent channels are spaced by exactly one channel bandwidth, a straightforward non-overlapping grid that simplifies frequency planning and coexistence. The 640 MHz mode provides a doubling of raw throughput potential relative to 320 MHz, enabling aggregate data rates that substantially exceed what is achievable in any sub-7 GHz Wi-Fi band. Optionally, 802.11bq supports single-user MIMO (SU-MIMO) with up to two spatial streams.

Two PPDU formats are defined. The IMMW SU PPDU is used for data transmission and constitutes the primary data-bearing format. The IMMW NDP (Null Data PPDU) serves beam management purposes, particularly beam tracking, without carrying user payload.

One of the more novel aspects of the 802.11bq PHY is the mmWave-specific preamble structure, referred to as the M-Preamble. Every IMMW PPDU begins with this M-Preamble, which consists of three sub-fields: the mmWave Short Training Field (M-STF), the mmWave Long Training Field (M-LTF), and a signal field (SIG). The M-Preamble serves the same fundamental purpose as preambles in sub-7 GHz systems, enabling initial synchronization, channel estimation, and signaling of PPDU parameters, but is designed specifically for the propagation and hardware characteristics of mmWave systems.

The M-Preamble is engineered with a design target of approximately 6 dB more reliability relative to the data portion at MCS0, ensuring that frame boundaries and control information can be recovered even under challenging channel conditions. The M-STF has a defined duration of 6.4 μs and employs frequency-domain duplication of the EHT short training sequence (specifically, the EHTS-120 sequence defined in 802.11ax/be), using a 2×frequency-domain duplication structure for 320 MHz PPDUs. The M-LTF reuses the 52-tone 20 MHz L-LTF sequence from the sub-7 GHz standard (with four additional tone values), duplicated across the full bandwidth using the EHT-LTF sequences EHTLTF-122,122 and EHTLTF-244,244 for 320 MHz and 640 MHz PPDUs, respectively. The GI for M-LTF is defined as 400 ns.

For 640 MHz PPDUs, the M-Preamble fields are constructed via frequency duplication of the 320 MHz format across both 320 MHz segments. Subcarrier spacing for both the preamble and data portions is uniformly 1.25 MHz, providing a fully consistent numerology end-to-end.

The SIG field structure is split into two sequential components: M-SIG, which serves a function analogous to the U-SIG field in 802.11be/bn (carrying universal PHY-layer parameters), followed by IMMW-SIG, which carries IMMW-specific parameters. This two-tier SIG architecture enables a consistent parsing flow for any device that understands the M-Preamble, while reserving IMMW-specific information in the second field.

The specification accommodates a range of antenna configurations at the IMMW STA. It explicitly supports non-AP STAs that use omnidirectional or quasi-omnidirectional antennas for transmission and/or reception, acknowledging that not every client device will deploy a high-gain phased array. Such omnidirectional STAs are required to support beam establishment and beam tracking procedures with directional IMMW STAs. Additionally, 802.11bq defines an Antenna Pattern Reciprocity capability field, allowing an IMMW STA to indicate whether its transmit and receive antenna patterns are the same for a given antenna weight vector. A polarization capability field is also defined, allowing IMMW APs and non-AP STAs to advertise their supported antenna polarizations, a consideration relevant to propagation diversity and link robustness at mmWave frequencies.

The MAC architecture of 802.11bq is deeply integrated with the Multi-Link Operation (MLO) framework introduced in 802.11be. A station affiliated with an MLD that supports mmWave operation is referred to as an IMMW STA; if it is an access point, it is an IMMW AP, and if a client, a non-AP IMMW STA. The crucial architectural constraint is that mmWave operation is inherently dependent on sub-7 GHz infrastructure: beam establishment, scheduling negotiation, and link management for the mmWave link are all conducted via the sub-7 GHz link. The mmWave link carries no Beacon frames, the sub-7 GHz link is responsible for all discovery, association, and network management.

This is a fundamental departure from 802.11ad and 802.11ay, where the mmWave link was self-contained with its own Beacon and management infrastructure. In 802.11bq, the sub-7 GHz link acts as a persistent control plane for the mmWave link, reducing mmWave overhead, enabling faster setup, and improving robustness to the intermittent connectivity characteristic of mmWave propagation.

Frame exchanges on the mmWave link in 802.11bq are tightly controlled through a Service Period (SP) mechanism. All transmissions on the mmWave link occur exclusively within pre-negotiated SPs; an IMMW STA is prohibited from transmitting to a peer IMMW STA outside of such a negotiated period. This disciplined scheduling approach prevents uncoordinated channel contention at mmWave frequencies, where the directional and bursty nature of links makes traditional CSMA/CA less effective.

Two types of SPs are defined: on-demand SPs, which are established dynamically as needed, and periodic SPs, which are negotiated once and recur on a defined cadence. Negotiation of both types occurs via the sub-7 GHz link. Within each SP, all frame exchanges (except those exclusively dedicated to beam establishment) are initiated by an Initial Control Frame/Initial Control Response (ICF/ICR) exchange, a lightweight handshake that gates access at the start of each SP. The SP model also identifies a single service period initiator for each period, ensuring deterministic channel access and avoiding ambiguity about which STA performs contention.

A dedicated channel access function is defined for beam establishment, separate from the general data channel access function. Additionally, the framework defines the SIFS duration for the IMMW link as 16 μs, compared to the much shorter SIFS values in sub-7 GHz operation, reflecting the different timing characteristics and processing requirements of mmWave hardware.

An IMMW AP MLD may support multiple IMMW links operating on non-overlapping mmWave channels simultaneously, which opens the door to increased aggregate capacity through spatial and frequency reuse at the AP. However, a non-AP MLD with a single mmWave radio is restricted to a single active IMMW link at any time.

Given the high path loss and inherently directional propagation at mmWave frequencies, beamforming is not optional, it is a fundamental requirement for any practical link. 802.11bq defines two categories of beamforming procedures: beam establishment and beam tracking.

Beam establishment is the process by which two IMMW STAs determine the antenna weight vectors (beam patterns) necessary to establish communication over the mmWave link. The procedure is assisted by the sub-7 GHz link: the negotiation of training parameters, including the target start time of the training sequence, the number of transmit sectors (M) to be trained, and the number of receive sectors (N) to be trained, with the constraint that M≥1, N≥1, and M+N>2, is exchanged via sub-7 GHz frames before any mmWave training occurs.

The sub-7 GHz-assisted approach to beam establishment offers significant practical advantages. The sub-7 GHz link, being omnidirectional and robust, is always available regardless of the current alignment state of the mmWave antennas. This means beam establishment can be initiated and coordinated even when the mmWave link is not yet operational, a bootstrapping advantage that the self-contained 802.11ad/ay approach could not easily achieve. The results of beam establishment are similarly reported back via the sub-7 GHz link.

A dedicated SP on the mmWave link may be negotiated between the IMMW AP and STA for conducting the beam establishment training sequence, ensuring the mmWave medium is available for training without contention.

Once a link is established, beam tracking procedures allow the two STAs to continuously optimize and maintain their antenna settings in response to device motion, environmental changes, and link quality variations, all of which are more pronounced at mmWave frequencies than in sub-7 GHz systems. A distinctive feature of 802.11bq's beam tracking approach is that training of multiple beams can be performed within a single PPDU transmission, improving efficiency by amortizing training overhead across a single packet exchange. Beam tracking feedback may be exchanged over the mmWave link itself, and the procedure can be initiated by an IMMW STA operating on the mmWave band. As with beam establishment, specific frames or NPDUs on the mmWave link may be defined or enhanced to carry beam tracking signaling and results.

Understanding 802.11bq is aided by appreciating where it differs from its predecessors. Both 802.11ad (WiGig) and 802.11ay are mmWave WLAN technologies operating in the 60 GHz band. While 802.11ad supports up to 7 Gbps with single-stream transmission, 802.11ay boosts this with MIMO and channel bonding, achieving up to 40 Gbps. Despite these high peak rates, neither standard achieved broad market penetration.

The IMMW approach addresses this differently at the architectural level. Rather than defining yet another self-contained mmWave PHY and MAC from scratch, 802.11bq reuses the OFDM numerology, tone plans, training sequences, and multi-link framework of the mainstream 802.11be/bn ecosystem. The implication for device implementers is significant: a single silicon design can support both sub-7 GHz and mmWave operation with shared DSP and MAC components, reducing the cost and power penalty associated with adding mmWave capability to a product. The large bandwidth available in the unlicensed bands between 42 GHz and 71 GHz, combined with the widely used 2.4, 5, and 6 GHz bands, creates an opportunity to meet demanding requirements, including those of augmented and virtual reality, proximity ranging, and sensing, even in dense environments.

IEEE 802.11bq (TGbq) represents a deliberate and architecturally coherent approach to bringing mmWave capability into the mainstream Wi-Fi ecosystem. By anchoring the mmWave link to a mandatory sub-7 GHz companion link within the MLO framework, it benefits from robust control signaling, simplified beam management, and a guaranteed fallback for network connectivity. The PHY reuses the 1.25 MHz OFDM numerology and tone plans from 802.11be, operating in 320 MHz and 640 MHz non-overlapping channels between 42 and 71 GHz, with a novel mmWave-specific preamble structure (M-Preamble) designed for reliable detection under challenging propagation conditions. The MAC introduces a strict service period scheduling model, coordinated via sub-7 GHz, which governs all mmWave frame exchanges, ensuring deterministic and efficient use of the directional mmWave channel. The specification framework reflects a growing body of group consensus, with formal motions covering numerology, preamble design, bandwidth modes, scheduling rules, beam management procedures, and antenna capability signaling.

The present disclosure relates to wireless local area networks (WLANs), and more particularly to methods, apparatus, and systems for performing beamforming setup and beamforming training in Integrated Millimeter Wave (IMMW) operation built on top of existing sub-7 GHz physical layer (PHY) and medium access control (MAC) protocols as defined under the IEEE 802.11 family of standards.

Millimeter wave (mmWave) frequency bands, generally comprising frequencies between 42 GHz and 71 GHz (including the widely deployed 60 GHz unlicensed band), offer substantially larger contiguous spectrum than the sub-7 GHz bands on which mainstream Wi-Fi has historically operated. However, prior mmWave Wi-Fi standards, specifically IEEE 802.11ad and IEEE 802.11ay, defined self-contained mmWave systems with their own independent PHY numerologies, MAC management structures, and beamforming training protocols. This standalone architecture imposed high implementation cost, precluded natural integration with the mainstream 802.11 ecosystem, and contributed to limited market adoption.

The Integrated Millimeter Wave (IMMW) paradigm, being standardized as IEEE 802.11bq, departs from this approach. Rather than defining mmWave as an independent system, IMMW builds mmWave operation directly on top of the PHY and MAC specifications already defined for sub-7 GHz operation. Under this architecture, an IMMW-capable multi-link device (MLD) must maintain at least one sub-7 GHz link in addition to any mmWave link it operates. The sub-7 GHz link serves as a persistent anchor for management, control, and signaling purposes. The mmWave link is operated in an on-demand fashion: it is powered on and activated only when data traffic requirements warrant its use. At all other times, the mmWave radio may be powered down or in a reduced-power state.

This on-demand operating model provides significant benefits in terms of power consumption and resource efficiency but introduces a class of problems that do not arise in the standalone mmWave architectures of 802.11ad/ay. Specifically, because the mmWave link is not continuously active, beamforming cannot be assumed to have been performed or to remain valid at the time the link is needed. Instead, beamforming must be performed on demand, shortly before the mmWave link is to be used for data transmission and must be coordinated efficiently between the initiating and responding stations using the always-available sub-7 GHz link.

Unlike sub-7 GHz Wi-Fi links, which can typically be closed using omnidirectional or mildly directional antennas, mmWave links suffer from high free-space path loss and are highly susceptible to blockage. As a result, directional beamforming, in which both the transmitting and receiving stations steer narrow antenna beams toward each other, is a fundamental requirement for reliable mmWave communication. Beamforming involves a training phase in which the transmitter sweeps across multiple transmit antenna sectors (or beam patterns) while the receiver simultaneously or sequentially sweeps across multiple receive sectors, enabling both sides to identify the combination of transmit and receive sectors that yields the strongest received signal. Following training, feedback is exchanged to inform the transmitter of the best sector combination identified by the receiver.

In IEEE 802.11ad and 802.11ay, the beamforming procedures, sector-level sweep (SLS) and beam refinement protocol (BRP), were designed for the standalone mmWave architecture and carry significant overhead in terms of signaling and frame complexity. These procedures include mechanisms for sector announcement, sector identification within beamforming frames, and feedback exchanges that are tightly coupled to the 60 GHz MAC. Because IMMW relies on the sub-7 GHz link for coordination and does not replicate the full 60 GHz management infrastructure of 802.11ad/ay, the beamforming procedures of those prior standards cannot be directly reused.

Previously, no beamforming setup procedure had been defined for IMMW. Sub-7 GHz beamforming protocols do not involve a setup phase. The sector-level sweep protocols of 802.11ad/ay do not include a separate setup negotiation stage. While the Beam Refinement Protocol (BRP) of 802.11ad/ay includes a setup exchange, it is designed for and tightly coupled to the standalone mmWave architecture and cannot be adapted to the IMMW context.

Furthermore, all existing IMMW beamforming proposals, including those that simplified the training procedure by leveraging sub-7 GHz assistance, assumed that each beamforming packet transmitted during the training sequence would include an explicit Antenna Sector ID field, identifying which transmit sector was in use for that particular packet. This assumption requires that the beamforming packet carry information beyond what is present in standard null data packet (NDP) formats defined for sub-7 GHz operation. If the IMMW beamforming packet is to be based on reusing existing NDP formats without modification to the PHY preamble, the inclusion of Antenna Sector ID signaling is not straightforward. Modifying the preamble to accommodate Sector ID signaling would require redesigning the IMMW NDP, adding complexity and potentially diverging from the design goal of maximizing PHY reuse from sub-7 GHz.

The present disclosure addresses both of these limitations: first, by providing a beamforming setup procedure that enables on-demand, negotiated establishment of beamforming parameters via the sub-7 GHz link; and second, by providing a beamforming training procedure that does not rely on the inclusion of Antenna Sector ID in the transmitted beamforming packets, instead using timing information to uniquely identify sectors, thereby enabling full reuse of existing NDP formats without preamble modification.

In a first aspect, the disclosure provides a beamforming setup procedure for IMMW that involves a Beamforming Request/Response frame exchange between a beamforming initiator and a beamforming responder, conducted over a sub-7 GHz link. This exchange enables the initiator and responder to negotiate and agree upon beamforming parameters, including the start time of the beamforming sequence at the mmWave link, the number of transmit and receive sectors to be trained, and beamforming feedback delivery mode, before the mmWave link is activated for the training sequence.

In a second aspect, the disclosure provides a beamforming training procedure in which Antenna Sector ID information is not embedded in the beamforming packets transmitted over the mmWave link. Instead, both stations rely on a pre-agreed timing schedule, the known beamforming start time, packet duration, and interframe spacing, to implicitly identify which transmit sector corresponds to each received packet. The responder feeds back timing information identifying when the best connection was observed during training, rather than explicit sector indices. The initiator maps this timing information back to the corresponding sector combination, thereby identifying the optimal transmit and receive sector pair.

These two aspects are complementary: the setup procedure of the first aspect establishes the shared timing and parameter state that the training procedure of the second aspect depends upon. Together they provide a complete, self-consistent, low-overhead beamforming solution for IMMW, which is compatible with the on-demand operating model and that minimizes PHY-layer changes relative to sub-7 GHz standards.

In the following description, the term “IMMW STA” refers to a station affiliated with a multi-link device (MLD) that supports operation on a mmWave link. An IMMW STA that is an access point is referred to as an “IMMW AP.” An IMMW STA that is a non-access-point station is referred to as a “non-AP IMMW STA.” An MLD that includes at least one affiliated IMMW STA shall also include at least one affiliated STA operating on an enabled sub-7 GHz link. The sub-7 GHz STA affiliated with the same MLD as an IMMW STA is referred to herein as the “sub-7 GHz STA” or “anchor STA.”

In some embodiments, the beamforming initiator is the IMMW AP (or its affiliated sub-7 GHz AP), and the beamforming responder is the non-AP IMMW STA (or its affiliated sub-7 GHz STA). However, the roles of initiator and responder are not limited to this assignment; the procedures described herein are applicable to any pair of IMMW STAs that have completed association and multi-link setup, including the mmWave link, over the sub-7 GHz infrastructure.

It is assumed that, prior to the beamforming setup exchange, the initiator and responder have completed association and multi-link setup (including the mmWave link) over the sub-7 GHz link, and have therefore already exchanged IMMW capability information, including each station's total number of beamforming sectors, during the association process. The beamforming setup procedure described herein therefore does not need to re-exchange fundamental capability information; it focuses exclusively on the operational parameters for the upcoming beamforming training event.

As described above, the on-demand operating model for the mmWave link means that beamforming is not performed at association time but rather at the point when the mmWave link is to be activated for data transmission. Because the mmWave link may have been inactive for an extended period since association, prior beamforming results (if any) may be stale or invalid, and both stations may need to negotiate fresh beamforming parameters before initiating the training sequence.

To support this, some embodiments disclosed herein provide a Beamforming Request/Response frame exchange that serves as the beamforming setup mechanism. This exchange occurs exclusively over the sub-7 GHz link, leveraging the always-available sub-7 GHz connectivity as the control channel for mmWave link management. No mmWave transmission occurs during the setup phase.

Both the Beamforming Request frame and the Beamforming Response frame are implemented as Action Acknowledge (Action Ack) frames, following the Action frame conventions established in the IEEE 802.11 MAC. The use of Action Ack frames provides reliable, acknowledged delivery of the beamforming setup negotiation, appropriate for a management-plane exchange that establishes the basis for subsequent mmWave physical-layer training.

The Beamforming Request frame is transmitted by the beamforming initiator to the beamforming responder over the sub-7 GHz link. It carries the proposed parameters for the upcoming beamforming training sequence. In some embodiments, the Beamforming Request frame includes the following information fields:

Start Time of Beamforming at the mmWave Link. This field specifies the proposed absolute start time at which the initiator intends to begin transmitting beamforming training packets on the mmWave link. The start time is expressed with sufficient precision to allow both stations to synchronize their mmWave radios and be ready for transmission and reception at the specified instant. Coordination of the start time via the sub-7 GHz link eliminates the need for any mmWave-level time-synchronization beacon or management frame, consistent with the IMMW design principle that no Beacon frames are transmitted on the mmWave link.

Number of Transmit Sectors (N). This field specifies the number of transmit antenna sectors at the initiator side that are to be trained during the upcoming beamforming sequence. In some embodiments supporting beam refinement (i.e., where beamforming covers only a subset of available sectors rather than the full sector sweep), a Beam Start Index field may also be included to indicate the index of the first sector in the training subset.

Number of Receive Sectors (M). This field specifies the number of receive antenna sectors at the responder side that are to be trained during the upcoming beamforming sequence. Similarly, in beam refinement embodiments, a corresponding Beam Start Index field may be included. Since the total number of sectors at both sides was exchanged during association, the initiator already has knowledge of the responder's total sector count; the M field in the Request frame specifies how many of those sectors will be covered in the current training event.

Training Sequence Timing Parameters (Optional). Optionally, the Beamforming Request frame may include the total duration of the beamforming training sequence, or equivalently the duration of each individual training frame and the inter-training frame time interval (ITFTI). In some embodiments where these parameters are fixed and standardized, this field need not be carried in the Request frame. In some embodiments where variable training frame durations or spacings are supported, explicit signaling of these parameters enables both stations to compute the precise timing of each training slot within the sequence.

Mandatory Listen Duration (Optional). Optionally, the Beamforming Request frame may include a mandatory listen duration, a time interval longer than the total training sequence duration, during which the responder is required to maintain its mmWave receive capability. This parameter accounts for the possibility that the initiator may encounter channel access delays or other conditions that cause the actual start of the mmWave training sequence to be delayed relative to the negotiated start time. By specifying a mandatory listen duration, the initiator ensures that the responder will not time out and abandon the receive operation before all training packets have been transmitted, even if the initiation is delayed.

Beamforming Feedback Delivery Mode. This field specifies whether beamforming feedback from the responder to the initiator, identifying the best transmit sector and receive sector identified during training, is to be delivered in a solicited mode (i.e., in response to an explicit Trigger frame from the initiator) or in an unsolicited mode (i.e., transmitted by the responder without waiting for a Trigger frame). In some embodiments, beamforming feedback is delivered over the sub-7 GHz link, not the mmWave link, consistent with the IMMW architecture in which the sub-7 GHz link serves as the control channel.

The Beamforming Response frame is transmitted by the beamforming responder to the beamforming initiator over the sub-7 GHz link in response to the Beamforming Request frame. It indicates whether the responder accepts the proposed beamforming parameters and, if not, whether it proposes modified parameters. The Beamforming Response frame includes a Status Code field and, depending on the status, a set of parameter fields mirroring those of the Request frame.

Status Code. The Status Code field takes one of at least three values:

SUCCESS: The responder accepts the beamforming parameters as proposed in the Request frame. The beamforming training will proceed at the specified start time, with the specified number of transmit and receive sectors, and with the specified feedback delivery mode.

REQUEST_DECLINED: The responder declines the beamforming request. This status may be returned when the responder is unable or unwilling to participate in beamforming at the proposed start time or with the proposed parameters, for example, if the responder cannot activate its mmWave radio at the specified time due to conflicting operations or insufficient preparation time.

REJECTED_WITH_SUGGESTED_CHANGES: The responder declines the proposed parameters but indicates willingness to perform beamforming if the initiator modifies the parameters as specified in the Response frame. This status enables a single round of negotiation without requiring an additional request-response exchange: the initiator receives the responder's counter-proposal in the same Response frame and may proceed with the modified parameters if it accepts them.

Parameter Fields (Conditional). When the Status Code is REJECTED_WITH_SUGGESTED_CHANGES, the Beamforming Response frame includes the same set of parameter fields as the Beamforming Request frame, Start Time, Number of Transmit Sectors (N), Number of Receive Sectors (M), optional Beam Start Index values, optional Training Sequence Timing Parameters, optional Mandatory Listen Duration, and Beamforming Feedback Delivery Mode, populated with the parameter values that the responder proposes in lieu of the initiator's original proposal. When the Status Code is SUCCESS, these fields may be omitted or echoed from the Request frame to confirm the agreed parameters. When the Status Code is REQUEST_DECLINED, these fields need not be populated.

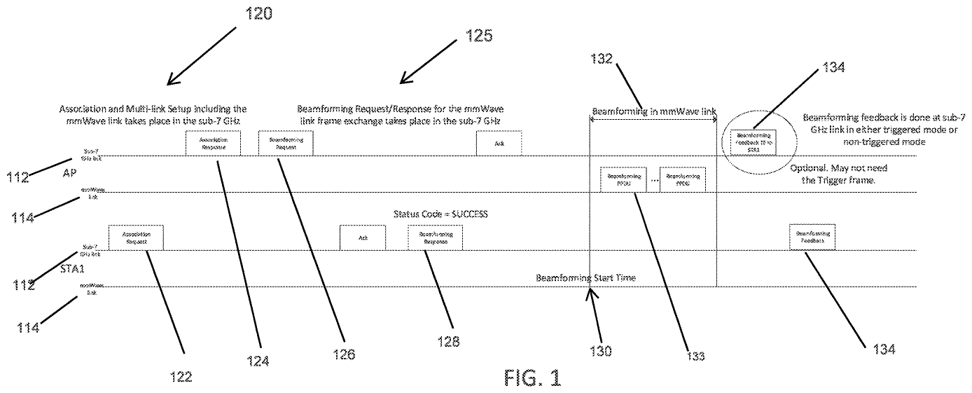

FIG. 1 illustrates an example Beamforming Request/Response frame exchange for Integrated Millimeter Wave (mmWave) (IMMW) networks, in accordance with some embodiments. As illustrated in FIG. 1, an integrated millimeter wave (IMMW) STA, when associated with another IMMW STA, is configured to perform a beamforming setup 125 with the other IMMW STA using a sub-mmW link 112 to determine beamforming parameters. The IMMW STA may activate a mmW link 114 and perform beamforming training 132 over the mmW link, once activated, using the beamforming parameters. The IMMW STA may communicate data via the mmW link 114 after performance of the beamforming training 132. In these embodiments, the IMMW STA may be configured to activate the mmW link 114 for performing the beamforming training at a target start time 130 that is determined during the beamforming setup 125.

Initially, the initiator (for example, the IMMW AP) and responder (for example, non-AP IMMW STA1) have previously completed an association and multi-link setup phase 120 over the sub-7 GHz link, including negotiation of the mmWave link. Both stations are in the associated state and have exchanged their respective IMMW capability information, including the total number of beamforming sectors at each station.

Next, the initiator determines that it wishes to use the mmWave link for data transmission to the responder. Prior to activating the mmWave link, the initiator transmits a Beamforming Request frame 126 to the responder over the sub-7 GHz link. The frame proposes a beamforming start time, the number of transmit sectors (N) to be trained, the number of receive sectors (M) to be trained, and a beamforming feedback delivery mode.

Next, if the responder is prepared to participate in beamforming at the proposed parameters, it returns a Beamforming Response frame 128 with a Status Code of SUCCESS. If the responder cannot accommodate the proposed parameters but proposes modifications, it returns a Beamforming Response frame with a Status Code of REJECTED_WITH_SUGGESTED_CHANGES and populates the parameter fields with its counter-proposal. If the responder declines entirely, it returns a Beamforming Response frame with a Status Code of REQUEST_DECLINED. Following a successful setup or following the initiator's acceptance of the responder's counter-proposal, both stations prepare for the beamforming training sequence on the mmWave link, beginning at the agreed start time.

Some embodiments relate to beamforming Training Without Antenna Sector ID. As noted above, existing IMMW beamforming proposals embed an explicit Antenna Sector ID in each beamforming training packet, enabling the responder to associate each received packet with the transmit sector that was used to send it. While conceptually straightforward, this approach introduces a dependency on Sector ID signaling in the beamforming packet format. If the IMMW beamforming packet is to fully reuse existing sub-10 GHz NDP formats, without introducing new PHY preamble fields, then Sector ID signaling cannot be accommodated without a preamble redesign.

Some of these embodiments may help eliminate this dependency by replacing explicit Sector ID signaling with implicit sector identification based on timing. The key insight is that, given a pre-agreed beamforming schedule, including the start time, the duration of each beamforming packet, and the interframe spacing, both the initiator and the responder can independently and deterministically compute the timing at which each (transmit sector, receive sector) combination will occur during the training sequence. The responder therefore does not need to read a Sector ID from each received packet; it only needs to record the time at which the best received signal was observed, and report that time in the feedback. The initiator, knowing the schedule, maps the reported time back to the corresponding sector combination.

This approach not only removes the requirement for Sector ID in the preamble but also simplifies the physical structure of the beamforming training frame. Because no data payload or sector identification needs to be decoded by the receiver, the training frame can be reduced to a sequence of short training symbols, analogous to the Short Training Field (STF) of the IEEE 802.11a preamble, with no requirement for the long training field (LTF) or signal (SIG) field. The receiver needs only to set its automatic gain control (AGC) and measure the received signal power for each training slot. This results in a lightweight, purely power-measurement-based training sequence that is compatible with full reuse of existing NDP-based frame structures.

In some embodiments, the beamforming training procedure without Sector ID is predicated on both the initiator and the responder sharing a common understanding of the beamforming schedule prior to the start of training. This shared schedule is established during the beamforming setup phase described above, and includes:
The beamforming start time T₀ at the mmWave link;
The interframe spacing between all consecutive beamforming packets (fixed and known to both stations);
The number of transmit sectors at the initiator side, N;
The number of receive sectors at the responder side, M; and
The transmission pattern: for each of the N transmit sectors, the initiator transmits M consecutive beamforming packets, one for each of the M receive sectors on the responder side.

Given these parameters, both the initiator and responder can independently construct a complete timing table of the form:

At time T_jk, the initiator is transmitting using Tx Sector j, and the responder is configured to receive using Rx Sector k.

where j∈{1, . . . , N} and k∈{1, . . . , M}, and T_jk is deterministically derived from T₀, the packet duration, and the interframe spacing.

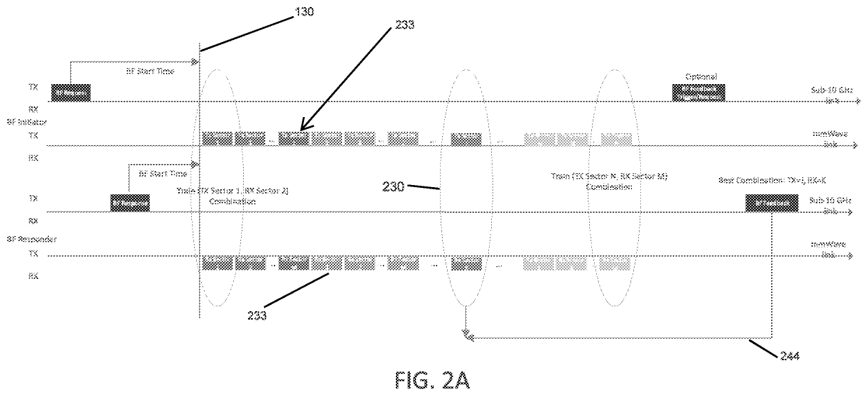

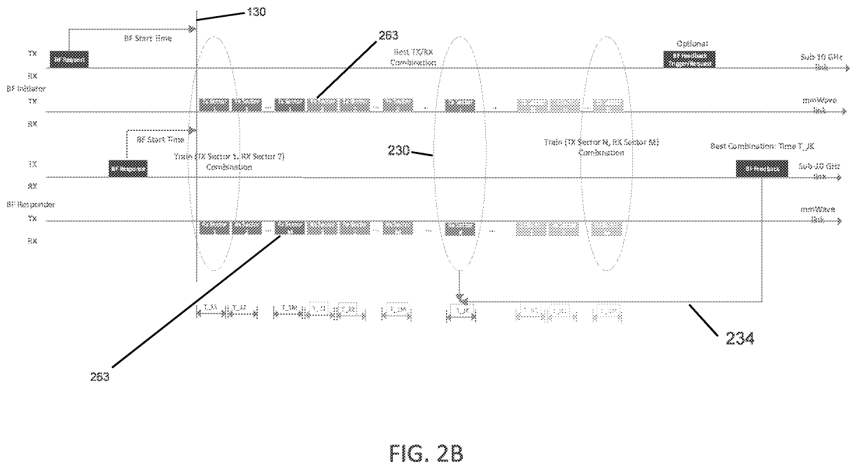

FIG. 2B illustrates the baseline beamforming training sequence in which Antenna Sector ID information is not included in the beamforming packets. This is to be contrasted with FIG. 2A, which illustrates the prior-art approach in which each packet includes an explicit Tx Antenna Sector ID. In FIG. 2B, the initiator begins transmission at the agreed start time T₀, transmitting M consecutive beamforming packets for each of its N transmit sectors, sweeping across all N sectors in sequence. Each packet is transmitted using a beamforming weight vector corresponding to the sector being trained but carries no in-packet indication of the sector index. The responder, beginning at T₀, cycles through its M receive sectors across the M consecutive packets received for each transmit sector.

At the conclusion of the training sequence, the responder identifies the combination of transmit and receive sectors that yielded the highest received signal power. Suppose this optimal combination is (Tx Sector J, Rx Sector K), observed at time TAJ. Because the responder does not know that the best packet was transmitted using Tx Sector J (since no Sector ID was sent), the responder cannot directly report sector indices. Instead, the responder includes the timing information TAJ in its beamforming feedback, along with the identity of the receive sector K (which the responder knows from its own receive schedule).

Upon receiving the feedback, the initiator looks up T_JK in its timing table and determines that this time corresponds to the transmission of Tx Sector J. The initiator therefore concludes that Tx Sector J is the optimal transmit sector for communication with the responder, while the responder has already identified Rx Sector K as its optimal receive sector. Both stations have thus identified their best beam settings through a simple timing lookup, with no Sector ID ever having been transmitted over the mmWave link.

A practical concern in any mmWave beamforming system is that either station may be unable to begin transmission or reception at precisely the negotiated start time, due to channel access delays, hardware preparation time, mmWave link activation latency, or channel switching. The timing-based approach of these embodiments is inherently robust to such delays, as described below.

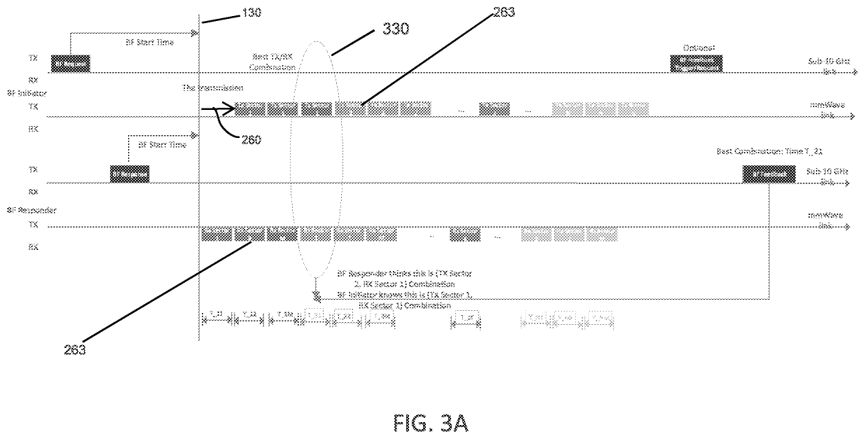

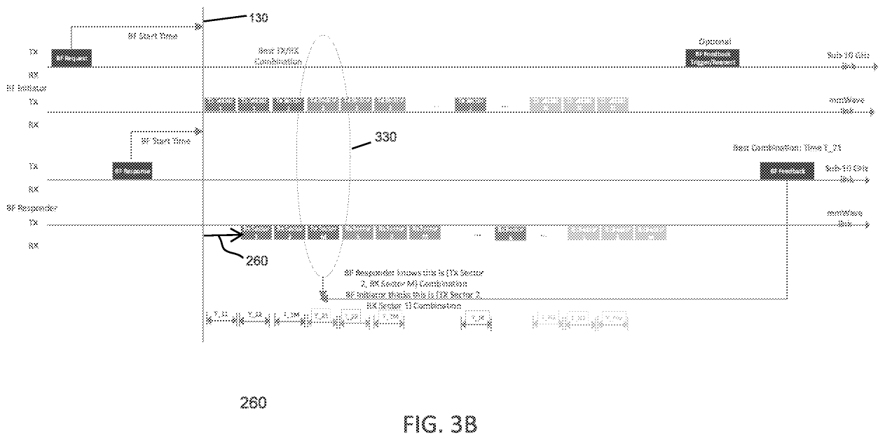

FIG. 3A illustrates the scenario in which the beamforming initiator (transmitter) experiences a delay and begins transmitting beamforming packets later than the agreed start time T₀. The responder is unaware of this delay and begins receiving (listening) at T₀ as planned. In this scenario, suppose the actual start time of the initiator's first transmission is T₀+Δ, where Δ is the transmit delay. As a result, the beamforming packets received by the responder are offset in time by Δ relative to the responder's expected schedule. Consequently, when the responder observes the best connection at time T_best, it computes the sector combination that corresponds to T_best according to the responder's original (unshifted) timing table and feeds back T_best accordingly.

From the responder's perspective, the best combination appears to be, say, (Tx Sector 2, Rx Sector 1), because the timing T_best, measured against the unshifted schedule, maps to (Tx Sector 2, Rx Sector 1). However, the initiator, knowing that it started late by Δ, applies a corrected timing table shifted by Δ. When the initiator maps T_best against the shifted schedule, it correctly identifies (Tx Sector 1, Rx Sector 1) as the true optimal combination. The transmit sector is identified correctly by the initiator, and the receive sector is identified correctly by the responder, despite the timing mismatch. No additional signaling or retransmission is required.

FIG. 3B illustrates the complementary scenario in which the beamforming responder (receiver) experiences a delay and begins receiving beamforming packets later than the agreed start time T₀. The initiator is unaware of this delay and begins transmitting at T₀ as planned.

In this scenario, the responder misses the first packets of the training sequence (those transmitted during the initial portion of the sweep while the responder has not yet activated its receive path). The responder begins receiving mid-sequence, aligned to a packet boundary. Because the responder knows its own delay, it adjusts its sector schedule accordingly: the first packet it actually receives corresponds not to (Tx Sector 1, Rx Sector 1) but to a later sector combination.

Suppose the actual optimal combination is (Tx Sector 2, Rx Sector M), observed at time T_best. The responder, applying its corrected (shifted) receive schedule, correctly identifies Rx Sector M as the receive sector corresponding to T_best. It feeds back T_best to the initiator. The initiator, whose transmit schedule was executed on time, maps T_best against the unshifted transmit-side timing table and correctly identifies Tx Sector 2 as the transmit sector corresponding to T_best.

Thus, even in the presence of a receive-side delay, both stations correctly identify the optimal sector combination through independent application of their respective (possibly shifted) timing tables. The mechanism is fully distributed: each station needs only to apply its own timing offset to arrive at the correct mapping, without requiring explicit signaling of the delay value to the other station.

Because the beamforming training procedure of these embodiments does not require the receiver to decode any data payload or sector identification field from the training frame, the structure of the training frame itself can be substantially simplified. In some embodiments, each beamforming training frame consists of a sequence of short training symbols, analogous to the Short Training Field (STF) of the IEEE 802.11a PHY preamble.

Using the 802.11a preamble as an analogy: the STF enables AGC and timing acquisition; the Long Training Field (LTF) enables channel estimation for data detection; and the SIGNAL field carries rate and length information for the subsequent data portion. In the conventional beamforming packet format with Sector ID, both channel estimation (to decode the Sector ID) and SIGNAL field decoding are required, necessitating LTF and SIGNAL fields. In these embodiments, the receiver only needs to measure received signal power for each training frame, it does not need to decode any content. Accordingly, the LTF and SIGNAL field are not needed; only the STF (or equivalent short training sequence) is required.

In some embodiments, the transmitter sends the same or different sequences of short training symbols, generated using the beamforming weight vector corresponding to the sector being trained, for each sector. The receiver sets its AGC based on the received STF energy and records the received power level for each training slot. The entire measurement and identification process is thus a power comparison across timing slots, with no content decoding required at any stage of the training sequence. This design is compatible with full reuse of existing NDP frame formats defined for sub-10 GHz operation, since the NDP preamble already contains the training symbols needed for signal power measurement, and no new PHY preamble field is needed.

The beamforming setup procedure and the beamforming training procedure described above operate together as an end-to-end IMMW beamforming solution. In these embodiments, when the initiator determines that the mmWave link is needed for data transmission, it transmits a Beamforming Request frame to the responder over the sub-7 GHz link. The Request frame establishes the shared timing schedule, T₀, N, M, and inter-frame spacings, which is required for the timing-based sector identification scheme.

In these embodiments, after a successful Beamforming Response exchange (Status Code =SUCCESS, or acceptance of REJECTED_WITH_SUGGESTED_CHANGES), both stations hold a common, agreed beamforming schedule. They activate their mmWave radios and prepare for training to begin at the agreed start time.

In these embodiments, the initiator sweeps through its N transmit sectors, transmitting M simplified training frames (short training symbol sequences) for each sector, according to the agreed schedule. The responder cycles through its M receive sectors across the M frames for each transmit sector, measuring received signal power at each slot.

In these embodiments, at the conclusion of the training sequence, the responder identifies the time T_JK of the best received power observation, computes Rx Sector K from its own receive-side schedule, and transmits beamforming feedback over the sub-7 GHz link (either solicited by a Trigger frame from the initiator, or unsolicited, per the feedback delivery mode agreed in the setup exchange).

In these embodiments, the initiator receives the feedback, maps T_JK to Tx Sector J using its transmit-side timing table, and both stations configure their respective mmWave antenna arrays to use the identified optimal sector combination for subsequent data transmission.

The complete procedure, from setup negotiation through training and feedback, operates without transmitting any management or control frames on the mmWave link (other than the training packets themselves), consistent with the IMMW architectural principle that no Beacon or management infrastructure exists on the mmWave link.

In alternative embodiments, the Beamforming Request and Response frames may be implemented as frame types other than Action Ack frames, including but not limited to standard Action frames, management frames with dedicated frame types, or control frames, depending on the desired reliability guarantees and the latency constraints of the application.

In alternative embodiments, the beamforming feedback may be delivered over the mmWave link rather than the sub-7 GHz link, for example, in scenarios where the mmWave link has already been partially established and the feedback channel is available on the mmWave frequency.

In alternative embodiments, the training frame format may include additional fields beyond the short training symbol sequence, for example, a subset of preamble fields for purposes other than sector identification, provided that the Antenna Sector ID field is absent and sector identification continues to rely on the timing-based mechanism described herein.

In alternative embodiments, the training sequence may support multi-beam training within a single transmitted PPDU, wherein multiple receive sectors are evaluated per transmitted packet through time-division of the receive antenna configuration within the packet duration.

In alternative embodiments, the roles of initiator and responder may be assigned to the non-AP IMMW STA and the IMMW AP, respectively, in scenarios where the non-AP STA initiates the beamforming process.

In alternative embodiments, the beamforming parameters may include training of only a subset of sectors (beam refinement mode), with the Beam Start Index fields used to identify the starting sector within each partial sweep.

In alternative embodiments applicable to deployments where an IMMW AP MLD has more than one IMMW link operating on non-overlapping channels in the mmWave band, the beamforming setup and training procedures described herein may be applied independently for each mmWave link, with each link's parameters separately negotiated via the sub-7 GHz anchor link.

In accordance with embodiments, an integrated millimeter wave (IMMW) STA, when associated with another IMMW STA, may be configured to perform a beamforming setup 125 with the other IMMW STA using a sub-mmW link 112 to determine beamforming parameters. The IMMW STA may activate a mmW link 114 and perform beamforming training 132 over the mmW link, once activated, using the beamforming parameters. The IMMW STA may communicate data via the mmW link 114 after performance of the beamforming training 132. In these embodiments, the IMMW STA may be configured to activate the mmW link 114 for performing the beamforming training at a target start time 130 that is determined during the beamforming setup 125.

In some embodiments, prior to association, an association and multi-link setup phase 120 may be performed over the sub-mmW link 112. In these embodiments, the association and multi-link setup phase 120 includes an exchange of STA capabilities including an exchange of basic IMMW capabilities of the IMMW STAs. As illustrated in FIG. 1, the association and multi-link setup phase 120 may comprise an exchange of an association request 122 and an association response 124 performed over the sub-mmW link 112. In these embodiments, the basic IMMW capabilities may include the fact that the STA is an IMMW STA having mmW link capability.

In some embodiments, the beamforming setup 125, that is performed over the sub-mmW link 112 with the other IMMW STA while associated with the other IMMW STA, comprises an exchange of a Beamforming Request frame 126 and a Beamforming Response frame 128 for negotiating and determining the beamforming parameters to be used during the beamforming training 132 over the mmW link 114. In these embodiments, during the beamforming setup 125, one IMMW STA may operate as a beamforming initiator and the another IMMW STA may operate as a beamforming responder.

In some embodiments, during performance of the beamforming setup 125, the mmW link 114 is configured to remain in an inactive state. In these embodiments, the IMMW STA may be configured to delay activation of the mmW link 114 for performing the mmW beamforming training 132 until the target start time 130.

In some embodiments, the beamforming parameters determined during the beamforming setup 125 for subsequent use in performing the beamforming training 132 may comprise the target start time 130; a number of transmit sectors (M) to be trained; and a number of receive sectors (N) to be trained.

In some embodiments, target start time 130 may account for the availability of both IMMW STAs to make sure they are both free as well as any activation delay of the mmWave link (e.g., the time needed for a IMMW STA to switch to the mmWave link and activate the link.

In some embodiments, when operating as a beamforming initiator to perform the beamforming training 132 after activation of the mmW link 114, the IMMW STA may be configured to transmit a beamforming packet 133 comprising a training sequence via the mmW link 114 for training each of transmit sectors and may be configured to receive a beamforming packet 133 for training each of the receive antenna patterns. In these embodiments, the IMMW STA is further configured to receive beamforming feedback 134 and determine a TX-RX beam pair for use in a data transmission (i.e., to communicate data) over the mmW link 114.

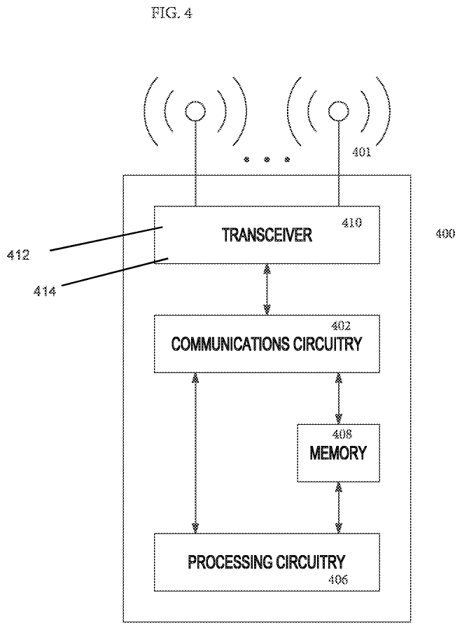

In some embodiments, each of the beamforming packets 233 (see FIG. 2A) comprise an antenna sector ID. In these embodiments, the processing circuitry 406 (FIG. 4) may be configured to determine the TX-RX beam pair 230 based on the antenna sector ID included in the beamforming feedback 244. An example of this is illustrated in FIG. 2A.

In some embodiments, the beamforming parameters determined during the beamforming setup 125 for subsequent use in performing the beamforming training 132 further comprise timing information. In these embodiments, the beamforming packets 263 transmitted and received during the beamforming training 132 may be devoid of an antenna sector ID (i.e., do not include an antenna sector ID) and comprise solely a sequence of sounding symbols. In these embodiments, the beamforming feedback 234 (FIG. 2B) received from the other IMMW STA includes feedback timing information. In these embodiments, the processing circuitry may be configured to identify the TX-RX beam pair 230 based on the feedback timing information (without use of an antenna sector ID).

In some embodiments, in addition to the target start time 130, the timing information included in the beamforming parameters includes a length of the beamforming packets and an interframe spacing between the beamforming packets 263. In these embodiments, the feedback timing information, included in the beamforming feedback 234, may indicate a time, relative to the target start time 130 (i.e., the time when the other IMMW station, operating as a beamforming responder, has the highest signal level (i.e., received signal power). In these embodiments, the IMMW STA, operating as the beamforming initiator, may be able to select the TX-RX beam based on the time indicating by the other IMMW station in the feedback timing information.

In some embodiments, the IMMW STA may adjust a time of the feedback timing information based on a channel access delay 260, if any, (see FIG. 3A and FIG. 3B) for selection of the TX-RX beam pair 330. In some embodiments, the data transmission over the mmW link 114 is triggered via signalling over the sub-mmW link 112 after completion of the beamforming training 132 and determination of the TX-RX beam pair although the scope of the embodiments is not limited in this respect as in some alternate embodiments, the data transmission over the mmW link 114 is triggered via signalling over the mmW link 114. In some embodiments, a TWT for periodic transmissions may be used for scheduling the data transmission. In some embodiments, the data transmission over the mmW link may be triggered on demand (i.e., when data becomes available for transmission).

In some embodiments, the data transmission comprises transmission of an IMMW PPDU having a mmW preamble (M-Preamble) that includes 320 MHz bandwidth fields including a M-STF, a M-LTF, and a SIG field. In these embodiments, for a 640 MHz bandwidth single user IMMW PPDU transmission, the 320 MHz bandwidth fields are frequency-duplicated on two adjacent 320 MHz bandwidths and are followed by an IMMW-STF and an IMMW-LTF that are transmitted across the 640 bandwidth.

In some embodiments, the sub-mmW link 112 comprises a link in the sub-7GHz frequency range between 2.4 to 7.25 GHz and the mmW link 114 comprises a link in the mmW frequency range between 42 and 71 GHz. In some embodiments, the transceiver circuitry 410 comprises a mmW transceiver 414 for communicating over the mmW link 114 and a sub-mmW transceiver 412 for communicating over the sub-mmW link 112 (see FIG. 4). In some alternate embodiments, the transceiver circuitry 410 may be a single transceiver with separate circuitry for communicating over the mmW link 114 and for communicating over the sub-mmW link 112.

In some embodiments, the IMMW STA may be configured to remain in an associated state with the other IMMW STA including during the data transmission over the mmW link 114. In these embodiments, the mmW link 114 carries no Beacon frames and has no independent management infrastructure. The sub-7 GHz anchor STA handles all standard 802.11 association maintenance, including Beacon reception, keep-alive exchanges, and any power management signaling (i.e., as a conventional sub-7 GHz Wi-Fi connection.

Some embodiments are directed to a non-transitory computer-readable storage medium that stores instructions for execution by processing circuitry of an integrated millimeter wave (IMMW) STA configured for integrated millimeter wave (IMMW) operation. In these embodiments, when the IMMW STA is associated with another IMMW STA, the processing circuitry may configure the IMMW STA to perform a beamforming setup 125 with the other IMMW STA using a sub-mmW link 112 to determine beamforming parameters and may activate a mmW link 114 and perform beamforming training 132 over the mmW link once activated using the beamforming parameters. The IMMW STA may communicate data via the mmW link 114 after performance of the beamforming training 132.

Some embodiments are directed to a method performed by processing circuitry of an integrated millimeter wave (IMMW) STA configured for integrated millimeter wave (IMMW) operation. In these embodiments, when the IMMW STA is associated with another IMMW STA, the method may comprise configuring the IMMW STA to perform a beamforming setup 125 with the other IMMW STA using a sub-mmW link 112 to determine beamforming parameters and activating a mmW link 114 and perform beamforming training 132 over the mmW link once activated using the beamforming parameters. The method may also comprise communicating data via the mmW link 114 after performance of the beamforming training 132.

FIG. 4 illustrates a functional block diagram of a wireless communication device, in accordance with some embodiments. In some embodiments, FIG. 4 illustrates a functional block diagram of a communication device (STA) that may be suitable for use as an AP STA, a non-AP STA or other user device in accordance with some embodiments. The wireless communication device 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device. In some embodiments, the wireless communication device 400 may be configured for Ultra-High Reliability (UHR) communications in accordance with an IEEE 802.11 (e.g., WiFi 8). Some embodiments are directed to an apparatus of a STA configured for operation in a WLAN comprising processing circuitry and memory.

The wireless communication device 400 may include communications circuitry 402 and transceiver circuitry 410 for transmitting and receiving signals to and from other communication devices using one or more antennas 401. The communications circuitry 402 may include circuitry that can operate the physical layer (PHY) communications and/or medium access control (MAC) communications for controlling access to the wireless medium, and/or any other communications layers for transmitting and receiving signals. The wireless communication device 400 may also include processing circuitry 406 and memory 408 arranged to perform the operations described herein. In some embodiments, the communications circuitry 402 and the processing circuitry 406 may be configured to perform operations detailed in the above figures, diagrams, and flows.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the wireless communication device 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the wireless communication device 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 400 may include one or more of a keyboard, a display, a non-volatile memory port, multiple antennas, a graphics processor, an application processor, speakers, and other mobile device elements. The display may be an LCD screen including a touch screen.

Although the wireless communication device 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 400 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An integrated millimeter wave (IMMW) STA configured for integrated millimeter wave (IMMW) operation, the STA comprising:
processing circuitry; and
transceiver circuitry for communicating over a mmW link and a sub-mmW link,
wherein when the IMMW STA is associated with an other IMMW STA, the processing circuitry is to:
configure the IMMW STA to perform a beamforming setup with the other IMMW STA using the sub-mmW link to determine beamforming parameters;
activate the mmW link and perform beamforming training over the mmW link using the beamforming parameters; and
communicate data via the mmW link after performance of the beamforming training.
wherein the processing circuitry is configured to activate the mmW link for performing the beamforming training at a target start time that is determined during the beamforming setup.

2. The IMMW STA of claim 1, wherein prior to association, an association and multi-link setup phase is performed over the sub-mmW link, and
wherein the association and multi-link setup phase includes an exchange of STA capabilities including an exchange of IMMW capabilities of the IMMW STAs.

3. The IMMW STA of claim 2, wherein the beamforming setup, which is performed over the sub-mmW link with the other IMMW STA while associated with the other IMMW STA, comprises an exchange of a Beamforming Request frame and a Beamforming Response frame for negotiating and determining the beamforming parameters to be used during the beamforming training over the mmW link.

4. The IMMW STA of claim 3, wherein during performance of the beamforming setup, the mmW link is configured by the processing circuitry to remain in an inactive state, and
wherein the IMMW STA is configured to delay activation of the mmW link for performing the mmW beamforming training until the target start time.

5. The IMMW STA of claim 4, wherein the beamforming parameters comprise:
the target start time;
a number of transmit sectors to be trained; and
a number of receive sectors to be trained.

6. The IMMW STA of claim 5, wherein when operating as a beamforming initiator to perform the beamforming training after activation of the mmW link, the IMMW STA is configured to transmit a beamforming packet comprising a training sequence via the mmW link for training each of transmit sectors and is configured to receive a beamforming packet for training each of the receive sectors, and
wherein the IMMW STA is further configured to:
receive beamforming feedback; and
determine a TX-RX beam pair for use in a data transmission over the mmW link.

7. The IMMW STA of claim 6, wherein each of the beamforming packets comprise an antenna sector ID, and
wherein the processing circuitry is configured to determine the TX-RX beam pair based on the antenna sector ID included in the beamforming feedback.

8. The IMMW STA of claim 6, wherein the beamforming parameters further comprise timing information, and
wherein the beamforming packets transmitted during the beamforming training are devoid of an antenna sector ID and comprise solely a sequence of sounding symbols,
wherein the beamforming feedback includes feedback timing information; and
wherein the processing circuitry is configured to identify the TX-RX beam pair based on the feedback timing information.

9. The IMMW STA of claim 8, wherein in addition to the target start time, the timing information included in the beamforming parameters includes one or more of:
a length of the beamforming packets; and
an interframe spacing between the beamforming packets, and
wherein the feedback timing information, included in the beamforming feedback, indicates a time, relative to the target start time.

10. The IMMW STA of claim 9 wherein the processing circuitry is further configured to adjust a time of the feedback timing information based on a channel access delay, if any, for selection of the TX-RX beam pair.

11. The IMMW STA of claim 6, wherein the data transmission over the mmW link is triggered via signalling over the sub-mmW link after completion of the beamforming training and determination of the TX-RX beam pair.

12. The IMMW STA of claim 11, wherein the data transmission over the mmW link is triggered on demand.

13. The IMMW STA of claim 6, wherein the data transmission comprises transmission of an IMMW PPDU having a mmW preamble (M-Preamble) that includes 320 MHz bandwidth fields including a M-STF, M-LTF, and SIG field, and
wherein for a 640 MHz bandwidth single user IMMW PPDU transmission, the 320 MHz bandwidth fields are frequency-duplicated on two adjacent 320 MHz bandwidths and are followed by an IMMW-STF and an IMMW-LTF that are transmitted across the 640 bandwidth.

14. The IMMW STA of claim 6, wherein the sub-mmW link comprises a link in a sub-7GHz frequency range between 2.4 to 7.25 GHz and the mmW link comprises a link in the mmW frequency range between 42 and 71 GHz.

15. The IMMW STA of claim 14, wherein the transceiver circuitry comprises a mmW transceiver for communicating over the mmW link and a sub-mmW transceiver for communicating over the sub-mmW link.

16. The IMMW STA of claim 6, wherein the IMMW STA is configured to remain in an associated state with the other IMMW STA including during the data transmission over the mmW link.

17. A non-transitory computer-readable storage medium that stores instructions for execution by processing circuitry of an integrated millimeter wave (IMMW) STA configured for integrated millimeter wave (IMMW) operation, wherein when the IMMW STA is associated with an other IMMW STA, the processing circuitry is to:
configure the IMMW STA to perform a beamforming setup with the other IMMW STA using a sub-mmW link to determine beamforming parameters;
activate a mmW link and perform beamforming training over the mmW link using the beamforming parameters; and
communicate data via the mmW link after performance of the beamforming training.
wherein the processing circuitry is configured to activate the mmW link for performing the beamforming training at a target start time that is determined during the beamforming setup.

18. The non-transitory computer-readable storage medium of claim 17, wherein prior to association, an association and multi-link setup phase is performed over the sub-mmW link, and
wherein the association and multi-link setup phase includes an exchange of STA capabilities including an exchange of IMMW capabilities of the IMMW STAs.

19. A method performed by processing circuitry of an integrated millimeter wave (IMMW) STA configured for integrated millimeter wave (IMMW) operation, wherein when the IMMW STA is associated with an other IMMW STA, the method comprising:
configuring the IMMW STA to perform a beamforming setup with the other IMMW STA using a sub-mmW link to determine beamforming parameters;
activating a mmW link and perform beamforming training over the mmW link using the beamforming parameters; and
communicating data via the mmW link after performance of the beamforming training.
wherein the processing circuitry is configured to activate the mmW link for performing the beamforming training at a target start time that is determined during the beamforming setup.

20. The method of claim 19, wherein prior to association, an association and multi-link setup phase is performed over the sub-mmW link, and
wherein the association and multi-link setup phase includes an exchange of STA capabilities including an exchange of IMMW capabilities of the IMMW STAs.
